(19) United States
(12) Patent Application Publication
(10) Pub. No.: US 2013/0254650 A1
(43) Pub. Date: Sep. 26, 2013

(54) SYSTEM FOR OFF-LINE EDITING A WEB PAGE

(71) Applicants: Chang-Sheng Huang, Taoyuan County (TW); Meng-Chia Yang, Taoyuan County (TW)

(72) Inventors: Chang-Sheng Huang, Taoyuan County (TW); Meng-Chia Yang, Taoyuan County (TW)

(21) Appl. No.: 13/673,409

(22) Filed: Nov. 9, 2012

(30) Foreign Application Priority Data
Mar. 23, 2012 (TW) 101110117

(51) Int. Cl. G06F 17/00

(52) U.S. Cl. 715/234

(57) ABSTRACT

A system for off-line editing a web page of a to-be-sold article using a mobile electronic device includes an editing unit to be installed in the mobile electronic device. The editing unit allows a user of the mobile electronic device to set properties of the web page and the to-be-sold article using a property setting interface, and generates image frames associated with the properties set by the user. Then, the editing unit generates the web page according to the image frames. The editing unit is configured to transmit the web page and the properties to a server so that the server is operable to generate and store article information of the to-be-sold article according to the properties.

### CROSS-REFERENCE TO RELATED APPLICATION

This application claims priority of Taiwanese Patent Application No. 101110117, filed on Mar. 23, 2012.

### BACKGROUND OF THE INVENTION

1. Field of the Invention

The present invention relates to a system for off-line editing a web page, more particularly to a system for off-line editing a web page of a to-be-sold article using a seller electronic device.

2. Description of the Related Art

A conventional system for editing a web page of a to-be-sold article usually requires a user electronic device, e.g., a personal computer or a mobile internet device, to communicate with a server via the Internet. Generally, the server provides a user interface that is to be displayed on the user electronic device, and that includes a plurality of options associated respectively with a plurality of properties of the web page. The user can select one of the options and edit the web page by setting the properties associated with the selected one of the options through the user interface.

However, it is necessary and inconvenient for the user of the user electronic device to connect to the server via the Internet when editing the web page.

### SUMMARY OF THE INVENTION

In the present invention, a system for off-line editing a web page of a to-be-sold article using a seller electronic device is provided for overcoming the drawback of the prior art mentioned hereinabove.

Accordingly, a system for off-line editing a web page of a to-be-sold article comprises an editing unit to be installed in a mobile electronic device for communicating with a server. The editing unit includes an image generating module, an image frame generating module, and a web page generating module. The image generating module is for generating a first graphical user interface to be displayed on a screen of the mobile electronic device. The first graphical user interface has a plurality of options that are associated respectively with a plurality of properties of the web page and the to-be-sold article. The image generating module further generates a property setting interface in response to selection of a selected one of the options selected by a user of the mobile electronic device. The image frame generating module is for generating an image frame when one of the properties is set by the user through the property setting interface. The image frame is associated with the one of the properties set by the user. The web page generating module is for generating the web page according to the image frame generated by the image frame generating module. The editing unit is configured to transmit the one of the properties to the server so that the server is operable to generate and store article information of the to-be-sold article according to the one of the properties.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a plurality of users using a preferred embodiment of a system for off-line editing a web page of a to-be-sold article using mobile electronic devices according to the present invention;

FIG. 2 is a block diagram illustrating the preferred embodiment of the system;

FIG. 3 is a flow chart illustrating a registration procedure for a seller;

FIG. 4 is a flow chart illustrating an editing procedure for editing the web page using the preferred embodiment of the system;

FIG. 5 is a schematic diagram illustrating a first user interface having a plurality of options to be displayed on a screen of the mobile electronic device;

FIG. 6 is a schematic diagram illustrating a property setting interface in response to selection of one of options shown in FIG. 5;

FIG. 7 is a schematic diagram illustrating a plurality of image frames associated respectively with the properties set by the user through the property setting interface;

FIG. 8 is a schematic diagram illustrating a web page generated by a web page generating module of the system according to the image frame;

FIG. 9 is a schematic diagram illustrating a second user interface to be displayed on a screen of another mobile electronic device; and

FIG. 10 is a schematic diagram illustrating a search result to be displayed on the screen of said another mobile electronic device.

### DETAILED DESCRIPTION OF THE PREFERRED EMBODIMENT

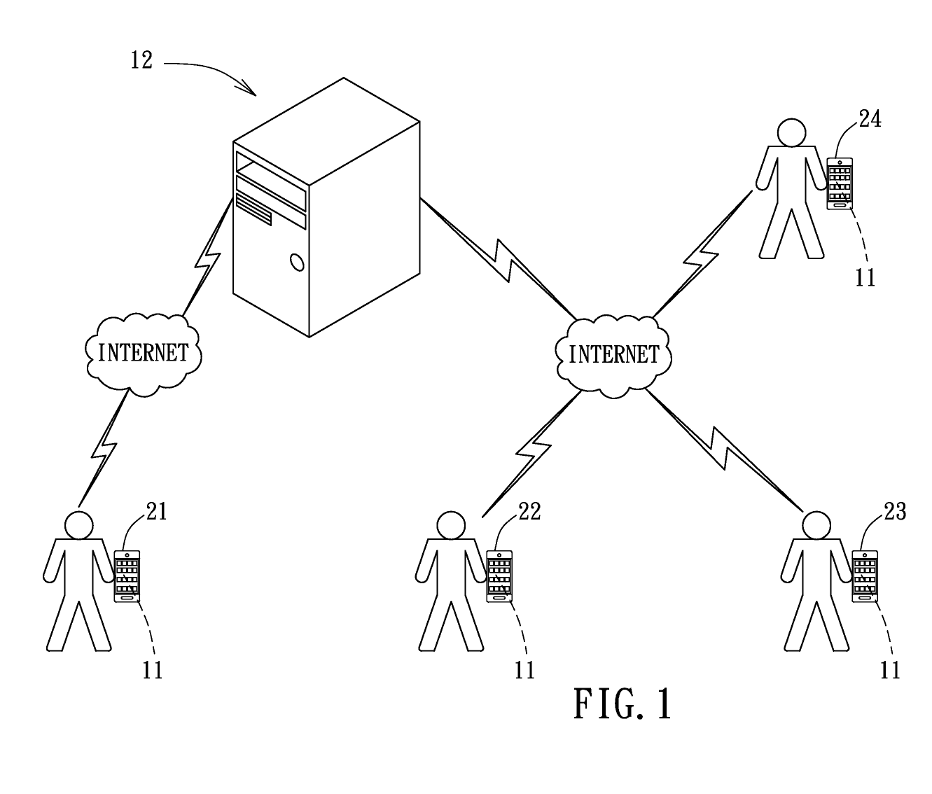

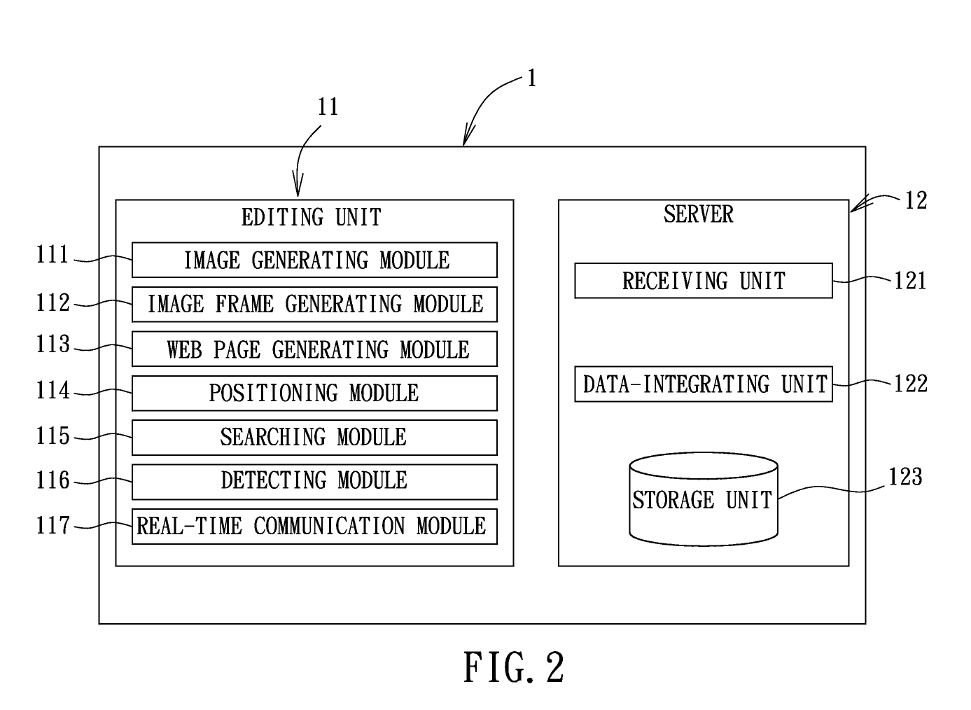

Referring to FIGS. 1 and 2, a preferred embodiment of a system 1, according to the present invention, is for off-line editing a web page of a to-be-sold article using a mobile electronic device 21. The system 1 comprises a server 12 and an editing unit 11 to be installed in the mobile electronic device 21 and another mobile electronic device 22 for communicating with the server 12. In this embodiment, the editing unit 11 is an application (APP) installed in the mobile electronic devices 21, 22. For example, a user of the mobile electronic device 21 is a potential seller who wants to sell a to-be-sold article using the system 1, and a user of the mobile electronic device 22 is a potential buyer who wants to purchase a to-be-sold article.

Each of the mobile electronic devices 21, 22 includes a global positioning system (GPS) and a wireless communication module (not shown) such as a wireless network module for communicating with the server 12. It can be appreciated that the editing unit 11 may be further installed in more mobile electronic devices 23, 24, i.e., the number of the seller and buyer electronic devices 21 to 24 installed with the editing unit 11 is not limited to the disclosure.

The editing unit 11 includes an image generating module 111, an image frame generating module 112, a web page generating module 113, a positioning module 114, a searching module 115, a detecting module 116, and a real-time communicating module 117.

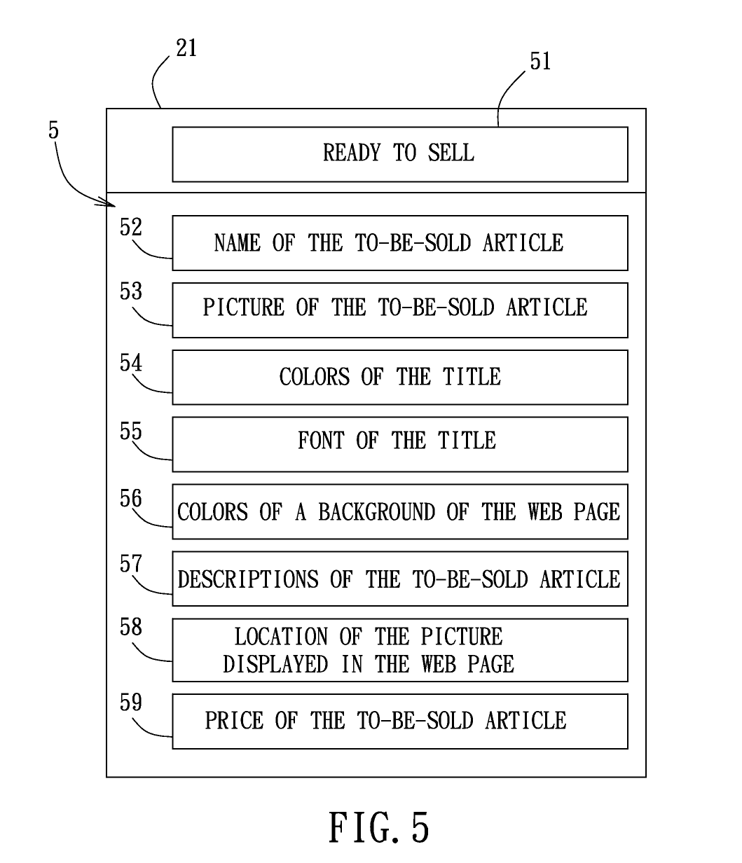

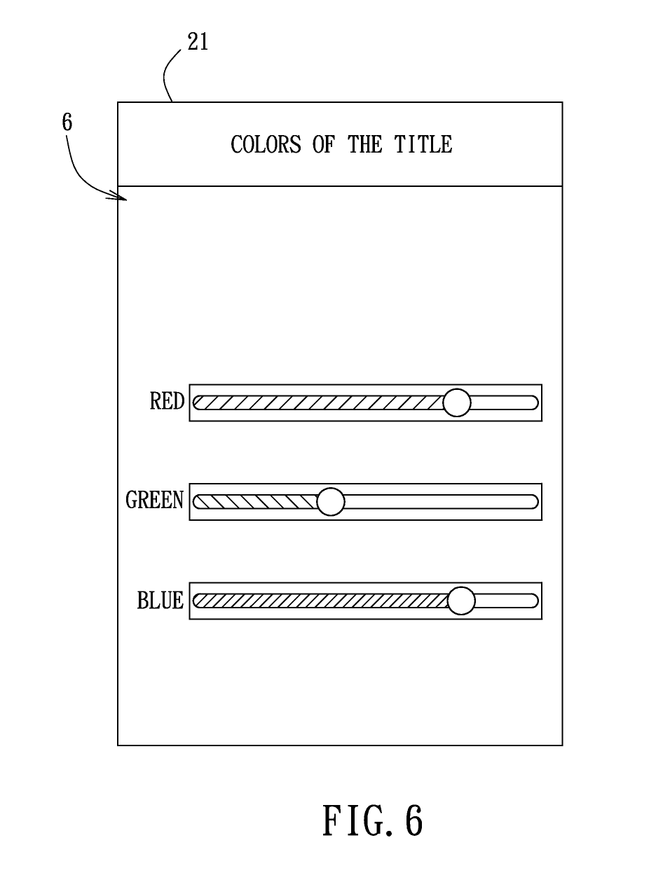

The image generating module 111 is for generating a first graphical user interface 5 to be displayed on a screen of the mobile electronic device 21 (see FIG. 5). The first graphical user interface 5 has a plurality of options 52 to 59 that are associated respectively with a plurality of properties of the web page and the to-be-sold article. The image generating module 111 further generates a property setting interface 6 (see FIG. 6) in response to selection of a selected one of the options 52 to 59 selected by a user of the seller electronic device 21.

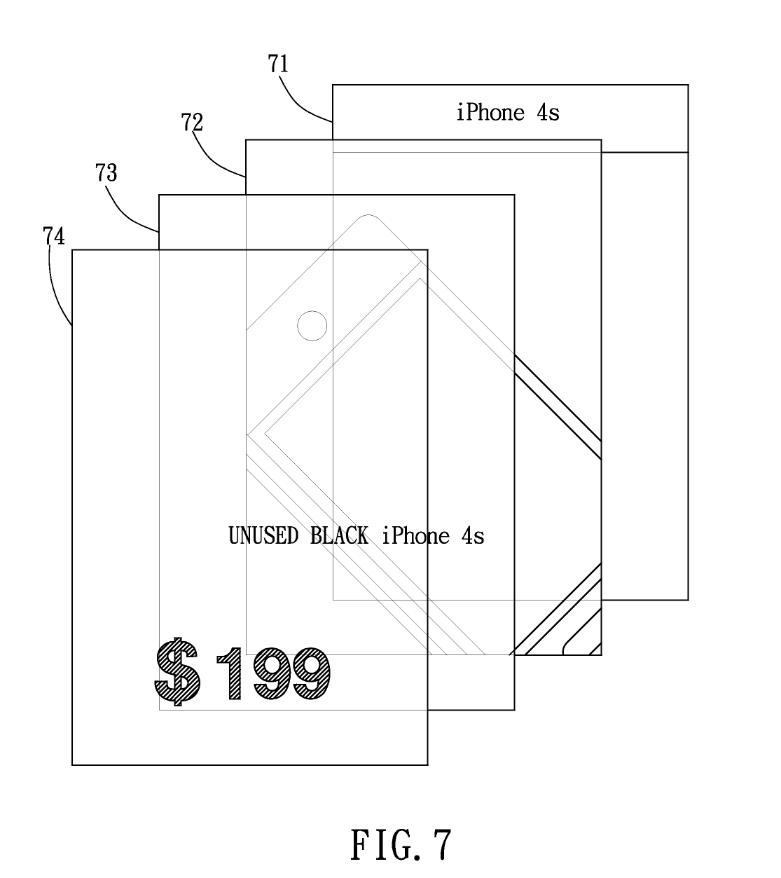

Further referring to FIG. 7, the image frame generating module 112 is for generating an image frame 71 to 74 when a corresponding one of the properties is set by the user through the property setting interface 6. Each of the image frames 71 to 74 is to be displayed on the screen of the mobile electronic device 21 and is associated with the corresponding one of the properties set by the user. The corresponding one of the properties set by the user is transmitted to the server 12 by the wireless communication module of the mobile electronic device 21.

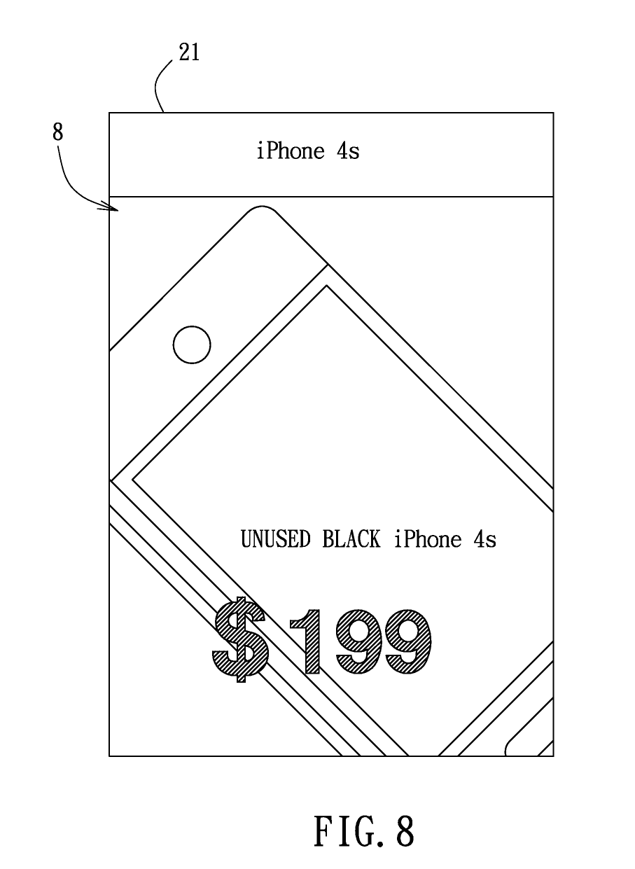

Further referring to FIG. 8, the web page generating module 113 is for generating a web page 8 according to the image frames 71 to 74. The positioning module 114 is for generating position data to be transmitted to the server 12 using the GPS of the seller and buyer electronic devices 21, 22.

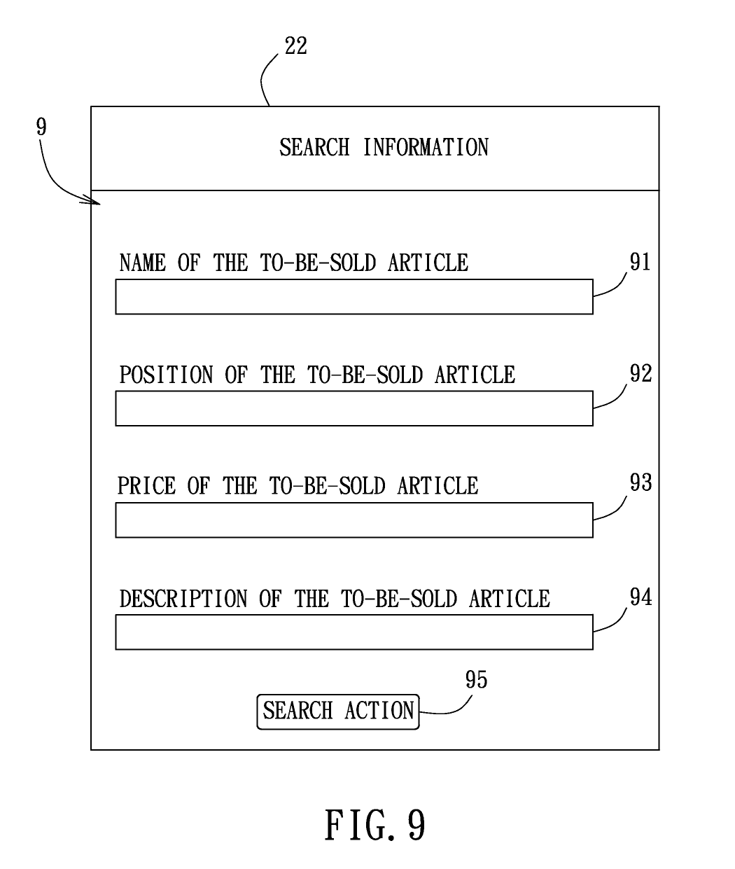

Further referring to FIG. 9, the image generating module 111 of the editing unit 11 is further for generating a second graphical user interface 9 to be displayed on the screen of the mobile electronic device 22. The second graphical user interface 9 allows the user of the mobile electronic device 22 to input at least one search information.

The searching module 115 is for retrieving the article information stored in the server 12 that matches the search information, and allows the screen of the mobile electronic device 22 to display the web page of the to-be-sold article associated with the article information.

The detecting module 116 is for detecting a specification of the screen of the mobile electronic device 22 to generate screen-specification data to be received by the server 12, so that the server 12 is operable, according to the article information and the screen-specification data, to generate the web page of the to-be-sold article that is to be displayed suitably by the screen of the mobile electronic device 22. The screen-specification data is indicative of resolution and a size of the screen of the mobile electronic device 22. The real-time communicating module 117 is for transceiving messages between the mobile electronic devices 21, 22.

The server 12 includes a receiving unit 121, a data-integrating unit 122, and a storage unit 123. The receiving unit 121 is a network module such as an Ethernet module or a Wireless Fidelity (Wi-Fi) module for receiving the web page and the properties set by the user of the mobile electronic device 21. The data-integrating unit 122 and the storage unit 123 respectively generate and store article information of the to-be-sold article according to the properties received from the mobile electronic device 21 and the position data generated by the positioning module 114. The data-integrating unit 122 is a software and is implemented by a processor (not shown) of the server 12. Additionally, the storage unit 123 is a data base conforming to structured query language (SQL) language standard.

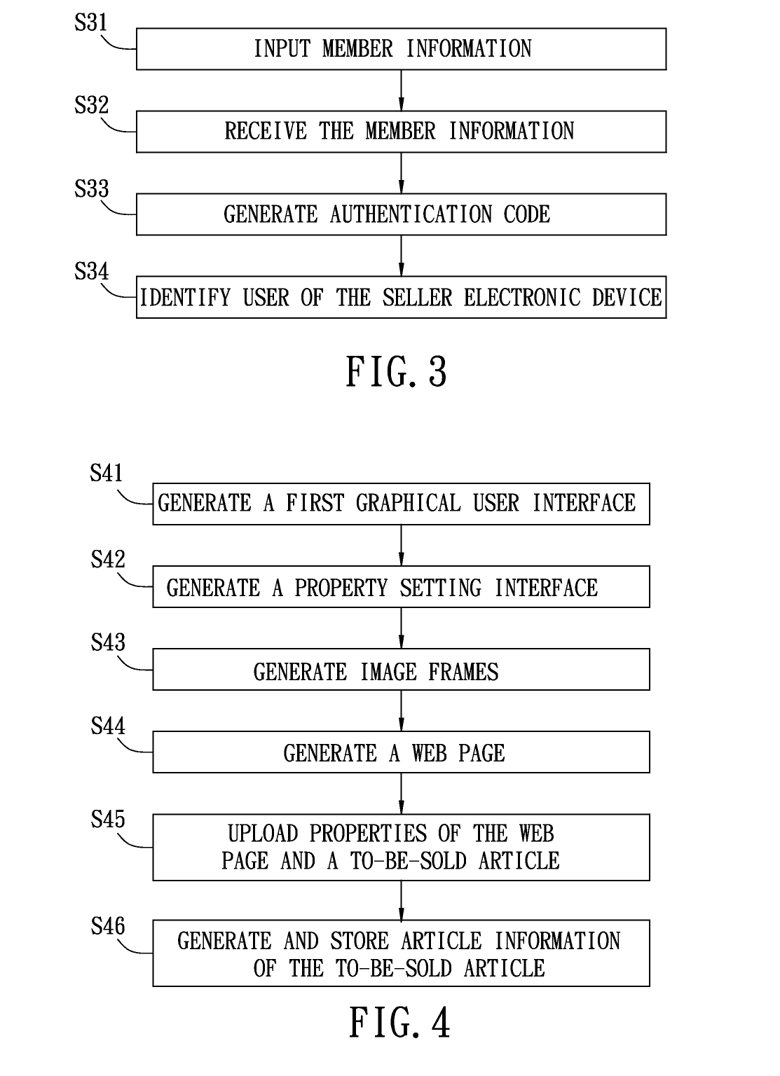

Further referring to FIGS. 3 and 4, an example for illustrating a registration procedure for the seller and an editing procedure for editing the web page using the preferred embodiment of the system 1 according to the present invention will be described in the following. First, when the editing unit 11 installed in the seller electronic device 21 is executed, the image generating module 111 is configured to generate the first graphical user interface 5 that is displayed on the screen of the seller electronic device 21.

In step S31, the first graphical user interface 5 is configured to allow the user (i.e., the seller) of the mobile electronic device 21 to input member information such as a username, passwords, a shop name, and a location of the shop, such that a registration process can be performed. The server 12 is configured to receive and identify the member information in step S32, and then to generate an authentication code to be received through the mobile electronic device 21 in step S33. Subsequently, in step 34, once identity of the seller has been verified, the registration process is completed.

In this embodiment, the username is an email address, which should not be an existing email address stored in the server 12, and the authentication code is sent by email in a form of hyperlink to the seller. After the seller receives the email by the mobile electronic device 21 and clicks the hyperlink, the registration process is completed. It is noted that the location of the shop may be inputted by the user or generated by the GPS of the mobile electronic device 21.

Further referring to FIG. 5, in step S41 of the editing procedure, the image generating module 111 generates the first graphical user interface 5 having a plurality of options 52 to 59 associated respectively with a plurality of properties of the web page 8 and the to-be-sold article. The options 52 to 59 are respectively a title of the web page 8 associated with a name of the to-be-sold article, a picture of the to-be-sold article, colors of the title, a font of the title, colors of a background of the web page 8, a description of the to-be-sold article, a location 58 of the picture 53 displayed in the web page 8, and a price 59 of the to-be-sold article. That is to say, the seller may customize the abovementioned properties of the web page 8 and the to-be-sold article as desired.

In step 42, the image generating module 111 is further configured to generate the property setting interface 6 (see FIG. 6) in response to selection of one of the options 52 to 59 by the seller. For example, when the option 54 indicating the color of the title is selected, the image generating module 111 generates the property setting interface 6 that has red, green, and blue (RGB) color (i.e., tricolor) properties to be set by the seller. It is noted that RGB color properties of the colors of the background of the web page 8 may also be set by the seller as desired.

Further, referring to FIG. 7, in step 43, the image frame generating module 112 is configured to respectively generate image frames 71 to 74 when the respective properties are set by the seller through the property setting interface 6.

For example, when the options 54, 53, 57 and 59 associated respectively with the colors of the title, the picture of the to-be-sold article, the description of the to-be-sold article, and the price of the to-be-sold article are selected, the respective associated properties are to be set by the seller and the image frame generating module 112 generates image frames 71 to 74 associated respectively with the properties of the options 54, 53, 57 and 59. In this embodiment, the description of the to-be-sold article is inputted as “Unused black iPhone 4S”, and the price of the to-be-sold article is set as “$199”. Since setting of RGB properties of the color of the title has been described in step 42, further details of the same are omitted.

As to the picture of the to-be-sold article, an image file stored in the mobile electronic device 21 can serve as the picture. Alternatively, the picture 53 of the to-be-sold article may be obtained by an image capturing element (not shown), which generates another image file, of the mobile electronic device 21.

Additionally, the property representing one of the options 58 corresponding to the location of the picture includes coordinate data indicative of a position of the picture to be displayed in the web page 8. The coordinate data includes four coordinate points indicative of location of four corners of the picture to be displayed in the web page 8.

It should be noted that the property, which is set by the user and indicates at least one of the title the web page associated with a name of the to-be-sold article, the colors of the title, and the font 55 of the title, the colors of the background of the web page, the location of the picture displayed in the web page, the description of the to-be-sold article, and the price 59 of the to-be-sold article, is stored in the mobile electronic device 21 in a text form.

As shown in FIG. 8, in step 44, the web page generating module 113 is configured to generate the web page 8 displayed on the screen of the seller electronic device 21 according to the image frames 71 to 74, each of which is associated with a corresponding one of the properties set by the user. Note that the web page 8 may be stored in the mobile electronic device 21 in an image format.

Hereafter, in step 45, when the seller is about to upload the properties and the web page 8 of the to-be-sold article to the server 12, the communication module of the mobile electronic device 21 is configured to upload the web page 8 and the properties stored in the mobile electronic device 21 in response to selection of one of the options 51 indicative of “ready to sell”.

Subsequently, in step 46, the data-integrating unit 122 and the storage unit 123 of the server 12 are respectively configured to generate and to store the article information of the to-be-sold article according to the properties and the position data generated by the positioning module 114.

Afterward, further referring to FIG. 9, the image generating module 111 of the editing unit 11 is configured to generate a second graphical user interface 9 displayed on the screen of the mobile electronic device 22. The second graphical user interface 9 allows the user of the mobile electronic device 22 (i.e., the buyer) to input at least one search information.

In this embodiment, the second graphical interface 9 has four options 91 to 94 that are respectively associated with a name of the to-be-sold article, a position of the to-be-sold article, a price of the to-be-sold article, and a description of the to-be-sold article, and that are to be arbitrarily selected by the buyer. For example, when the description of the to-be-sold article associated with one of the options 94 is inputted as “black iPhone” by the buyer, and then another one of the options 95 associated with a search action is subsequently selected, the searching module 115 is then configured to retrieve the article information stored in the server 12 that matches the search information (i.e., “black iPhone”) inputted by the buyer. It can be appreciated that a location of the mobile electronic device 22 is taken into consideration while retrieving the article information stored in the server 12.

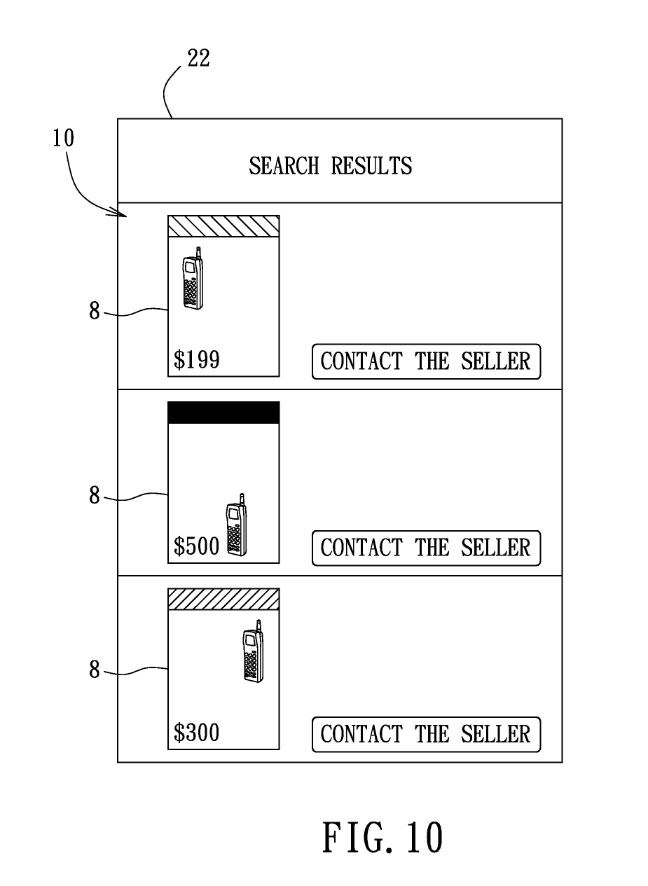

Later, the editing unit 111 is configured to allow the screen of the mobile electronic device 22 to display the web page of the to-be-sold article associated with the article information. As shown in FIG. 10, for example, there are three to-be-sold articles having an article information matching the search information associated with the title of the to-be-sold article of “black iPhone”. As can be seen, colors of the title and location of picture displayed in the web pages 8 of the three to-be-sold articles are different.

It should be noted that since the specification of the screens of the mobile electronic devices 21, 22 may be different, the detecting module 116 is configured to detect the specification of the screen of the mobile electronic device 22 to generate screen-specification data to be received by the server 12. By this way, the server 12 is configured, according to the article information and the screen-specification data, to adjust the web pages 8 of the to-be-sold articles so as to generate a search-result image 10 to be displayed suitably on the screen of the buyer electronic device 22.

Additionally, the real-time communicating module 117 is configured to transceive messages between the mobile electronic devices 21, 22. It can be appreciated that the communication between the seller and the buyer may be conduct by means of any available software (e.g., Microsoft® Network (MSN) or What's APP) or Short Message Service (SMS).

To sum up, the web page generating module 113 of the editing unit 11 generates the web page 8 according to the image frames 71 to 74 associated with the properties set by the seller. Further, since the properties set by the seller are stored in the mobile electronic device 21 in a text form and the web page 8 is stored in the mobile electronic device 21 in an image format, it is not necessary to connect to the server 12 while editing the web page 8.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for off-line editing a web page of a to-be-sold article using a mobile electronic device, said system comprising:
an editing unit to be installed in the mobile electronic device for communicating with a server, said editing unit including
an image generating module for generating a first graphical user interface to be displayed on a screen of the mobile electronic device, the first graphical user interface having a plurality of options that are associated respectively with a plurality of properties of the web page and the to-be-sold article, said image generating module further generating a property setting interface in response to selection of a selected one of the options selected by a user of the mobile electronic device,
an image frame generating module for generating an image frame when one of the properties is set by the user through the property setting interface, the image frame being associated with said one of the properties set by the user, and
a web page generating module for generating the web page according to the image frame generated by said image frame generating module;
wherein said editing unit is configured to transmit the web page and said one of the properties to the server so that the server is operable to generate and store article information of the to-be-sold article according to said one of the properties.

2. The system as claimed in claim 1, wherein the options of the first graphical user interface include a title of the web page associated with a name of the to-be-sold article, colors of the title, a font of the title, colors of a background of the web page, a picture of the to-be-sold article, a location of the picture displayed in the web page, a description of the to-be-sold article, and a price of the to-be-sold article.

3. The system as claimed in claim 2, the mobile electronic device further including a global positioning system (GPS),
wherein said editing unit further includes a positioning module for generating position data using the GPS of the mobile electronic device, and is configured to further transmit the position data to the server so that the server is operable to generate and store the article information of the to-be-sold article further according to the position data.

4. The system as claimed in claim 3, wherein said image generating module of the editing unit is further for generating a second graphical user interface to be displayed on the screen of the mobile electronic device, the second graphical user interface allowing the user of the mobile electronic device to input at least one search information,
wherein said editing unit further includes a searching module for retrieving the article information stored in the server that matches the search information, and allows the screen of the mobile electronic device to display the web page of the to-be-sold article associated with the article information.

5. The system as claimed in claim 4, wherein the search information matches at least one of the title of the to-be-sold article, the price of the to-be-sold article, and the description of the to-be-sold article.

6. The system as claimed in claim 4, wherein said editing unit further includes a detecting module for detecting a specification of the screen of the mobile electronic device to generate a screen-specification data to be received by the server, so that the server is operable, according to the screen-specification data, to adjust the web page of the to-be-sold article to be displayed suitably on the screen of the mobile electronic device.

7. The system as claimed in claim 6, wherein the screen-specification data is indicative of resolution and a size of the screen of the mobile electronic device.

8. The system as claimed in claim 2, wherein the property, which is set by the user and indicates at least one of the title of the web page associated with the name of the to-be-sold article, the colors of the title, the font of the title, the colors of the background of the web page, the location of the picture displayed in the web page, the description of the to-be-sold article, and the price of the to-be-sold article, is stored in the mobile electronic device in a text form.

9. The system as claimed in claim 2 wherein the property indicative of the picture of the to-be-sold article is related to an image file, and the property indicative of the location of the picture includes coordinate data indicating a position of the picture to be displayed on the screen of the mobile electronic device.

10. The system as claimed in claim 1, wherein said editing unit is further to be installed in another mobile electronic device, and said editing unit further includes a real-time communicating module for transceiving messages between seller and buyer electronic devices.
